(19) United States
(12) Patent Application Publication
(10) Pub. No.: US 2007/0063539 A1
(43) Pub. Date: Mar. 22, 2007

(54) Snap-in mounting clip, panel having a snap-in mounting clip, and method of mounting the panel

(76) Inventors: Joseph DiMario, Troy, MI (US); John Helner, Lake Orion, MI (US)

Correspondence Address: Intellectual Property Department;PPG INDUSTRIES, INC., One PPG Place, Pittsburgh, PA, 15272, US

(21) Appl. No.: 11/602,578

(22) Filed: Nov. 21, 2006

Related U.S. Application Data
(63) Continuation-in-part of application No. 11/486,789, filed on Jul. 14, 2006.
(60) Provisional application No. 60/716,372, filed on Sep. 12, 2005.

(51) Int. Cl. B60J 1/00; A47B 96/06; E04G 3/00

(52) U.S. Cl. 296/146.15; 248/216.1; 248/216.4; 248/71

(57) ABSTRACT

Snap-in mounting or glazing clips are mounted on a surface of a panel, and the panel moved toward an opening to move flexible engaging members or legs of the clips into their respective one of a plurality of holes in a flange defining the opening. As the snap-in clips move through their respective hole, the engaging members move toward one another to move from an unbiased condition toward a biased condition. When the panel is in position over the opening, the legs are in contact with the flange and are in one of the following conditions: (1) a biased condition between a fully biased condition and a fully unbiased condition and (2) the fully unbiased condition to secure the panel over the opening.

### RELATED APPLICATIONS

This application is related to U.S. application Ser. No. 11/486,789 entitled “METHOD OF MOUNTING A PANEL OVER AN OPENING, DEVICES FOR SECURING PANELS OVER AN OPENING, AND PANELS HAVING THE DEVICES”; U.S. application Ser. No. 11/486,790 entitled “DEVICES FOR SECURING PANELS OVER AN OPENING, AND PANELS HAVING THE DEVICES”; U.S. application Ser. No. 11/486,918 entitled “DEVICES FOR SECURING PANELS OVER AN OPENING, AND PANELS HAVING THE DEVICES”; and U.S. application Ser. No. 11/486,919 entitled “DEVICES FOR SECURING PANELS OVER AN OPENING, AND PANELS HAVING THE DEVICES”; each filed on Jul. 14, 2006. These applications are herein incorporated by reference in their entirety. This application also claims the benefits of U.S. Application Ser. No. 60/716,372, filed Sep. 12, 2005.

### BACKGROUND OF THE INVENTION

1. Field of the Invention

This invention relates to snap-in glazing or mounting clip, a panel having the snap-in mounting clips and method of mounting the panel having the mounting clips to secure the panel in a recess having an opening, and more particularly, to snap-in mounting clips securely mounted on an automotive transparency, e.g. a quarter panel for a van, the clips having a mechanical arrangement that passes through a hole in the flange defining the opening and engages the flange to secure the transparency over the opening.

2. Discussion of the Available Technology

Land vehicles, e.g. cars, trucks, trains and buses are provided with either fixed or moveable transparencies or glass windows. Of particular interest in this discussion, but not limiting to the invention, are the mounting of fixed transparencies and/or the replacement of damaged fixed transparencies. Usually, fixed vehicular transparencies, e.g. windshields, rear windows, and quarter windows or panels are secured over an opening in the body of the vehicle by applying a bead or layer of a curable or thermosetting structural adhesive on the inner marginal edge portions of the transparency and, thereafter, biasing the transparency toward the outer surface of the flange defining the opening to flow the adhesive layer between the flange and the transparency. The transparency is securely mounted over the opening after the adhesive layer cures. Optionally, a gasket and/or a weather seal is provided between the transparency and the adjacent portions of the vehicle body to prevent water from moving through the opening into the vehicle interior.

As can be appreciated by those skilled in the art, the replacement of a damaged transparency is time consuming and expensive. More particularly, the damaged transparency or pieces of the damaged transparency and the adhesive layer are removed from the outer surface of the flange. The time to complete the removal and cleaning steps depends on the size of the transparency being replaced. As a general statement, the time required to carry out the manual steps to remove a damaged windshield and mount a replacement windshield in the opening is in the time range of 24 to 45 minutes, and the time for the adhesive to fully cure is in the time range of one day to a week depending on the environment and the type of adhesive used.

To overcome the drawback of the long curing time, and to accommodate the desire of the vehicle owner to have and drive the vehicle, the usual practice is to apply strips of tape over the marginal edge of the transparency and the body of the vehicle to hold the transparency in place while the adhesive cures. As an added precaution, it is recommended not to washing the car for at least 8 hours.

As can be appreciated by those skilled in the art, it would be advantageous to provide a technique to replace a damaged transparency that does not have the limitations of the presently available procedure. More particularly, provide a technique that is more cost effective than the presently available procedures, and to provide a mounting system for mounting transparencies such that the transparencies are securely mounted in the opening in a shorter time period than the presently available mounting systems by, among other things, eliminating the need for the structural adhesive.

### SUMMARY OF THE INVENTION

The present invention provides a panel, comprising: a sheet having a peripheral edge, a first major surface and an opposite second major surface; and at least one snap-in mounting clip securely mounted on a marginal edge portion of the first major surface of the sheet. The mounting clip comprises: a base having a first surface in facing relationship to the first surface of the sheet and an opposite second surface; a body member having a first end and an opposite second end with the first end of the body member secured to the base and the second end spaced and extending away from the second surface of the base; and first and second flexible engaging members securely mounted on the body member and extending away from one another and the body member toward the second surface of the base, each of the engaging members terminating in an end spaced from the second surface of the base, wherein the engaging members in an unbiased condition have their respective ends spaced a first predetermined distance from one another and in an biased condition have their respective the ends spaced a second predetermined distance from one another, wherein the first predetermined distance is greater than the second predetermined distance.

The present invention also provides a snap-in mounting clip, comprising: a base having a major surface; a body member having a first end and an opposite second end, with the first end of the body member connected to the base and the second end of the body member being spaced and extending away from the major surface of the base; and first and second flexible engaging members securely mounted on the body member, spaced from the first end of the body member and extending away from one another and the body member toward the major surface of the base, each of the engaging members terminating in an end spaced from the major surface of the base, wherein the engaging members in an unbiased condition have their respective ends spaced a first predetermined distance from one another and the engaging members in an biased condition have their respective ends spaced a second predetermined distance from one another, wherein the first predetermined distance is greater than the second predetermined distance.

The present invention further provides a method of mounting a panel over an opening in a body, the opening defined by end portions of a flange, the flange having an outer surface facing away from the body, an opposite inner surface and at least one hole, comprising: (1) providing a panel comprising: (a) a sheet having a peripheral edge, a first major surface and an opposite second major surface, and (b) at least one snap-in mounting clip securely mounted on a marginal edge portion of the first major surface of the sheet, the mounting clip comprising: (i) a base having a first surface in facing relationship to the first surface of the sheet, and an opposite second surface; (ii) a body member having a first end and an opposite second end, with the first end of the body member secured to the base and the second end of the body member spaced and extending away from the second surface of the base; and (iii) first and second flexible engaging members securely mounted on the body member at least in close proximity to the second end of the body member and extending away from one another and the body member toward the second surface of the base, each of the engaging members terminating in an end spaced from the second surface of the base, wherein the engaging members in a fully unbiased condition have their respective ends spaced a first predetermined distance from one another and in a fully biased condition have their respective ends spaced a second predetermined distance from one another, wherein the first predetermined distance is greater than the second predetermined distance; (2) moving the panel toward the opening to move the second end of the body member of the clip toward the hole in the flange, wherein the flexible engaging members are in the fully unbiased condition; and (3) continuing the practice of the moving step to sequentially move the second end of the body member into the hole of the flange, move the flexible members toward one another toward the fully biased condition, move the second end of the body member and portions of the engaging member through and out of the hole until the end of the flexible engaging members engage the inner surface of the flange and the flexible engaging members are in one of the following conditions: a biased condition between the fully biased condition and the fully unbiased condition and the fully unbiased condition, to secure the panel over the opening.

### BRIEF DESCRIPTION OF THE DRAWING

FIG. 1 is an elevated isometric back-side view of a van having panels of the invention mounted or secured in accordance to the invention to selected ones of the flanges defining openings in the body of the van.

FIG. 2 is a view taken along lines 2-2 of FIG. 1 illustrating a non-limiting embodiment of a generic design of a glazing or mounting clip of the invention to secure the panel of the invention to a flange defining an opening in the body of the van.

FIG. 3 is an elevated fragmented isometric interior view of an opening in the body of the van having a panel of the invention mounted in the opening in accordance to a non-limiting practice of the invention.

FIG. 4 is an elevated fragmented isometric exterior view of the opening of FIG. 3.

FIG. 5 is an elevated isometric view of a non-limiting embodiment of a snap-in glazing clip of the invention.

FIG. 6 is an elevated fragmented isometric view of a panel having the glazing clip of FIG. 5 securely mounted on a surface of the panel.

FIG. 7 is an elevated fragmented side view of the panel of FIG. 6 moving into a recess in the body of the van of FIG. 1.

FIG. 8 is a view similar to the view of FIG. 7 showing the panel secured in the recess of the van in accordance to a non-limiting practice of the invention.

FIG. 9 is a side elevated view of another non-limiting embodiment of a snap-in glazing clip of the invention.

FIG. 10 is a view similar to the view of FIG. 9 showing still another non-limiting embodiment of a snap-in glazing clip of the invention.

FIG. 11 is an elevated fragmented side view of a panel secured in the recess of the van using the glazing clip shown in FIG. 10 in accordance to a non-limiting practice of the invention.

FIG. 12 is an elevated isometric view of still another non-limiting embodiment of a snap-in glazing clip of the invention.

FIG. 13 is a view taken along lines 13-13 of FIG. 12.

FIG. 14 is a view taken along lines 14-14 of FIG. 12.

FIG. 15 is an elevated fragmented side view of a panel having the glazing clip of FIG. 12 securely mounted on the panel moving into a recess in the body of the van of FIG. 1.

FIG. 16 is an elevated isometric view of an additional non-limiting embodiment of a snap-in glazing clip of the invention.

FIG. 17 is an elevated fragmented side view of a panel having the glazing clip of FIG. 16 securely mounted on the panel moving into a recess in the body of the van of FIG. 1.

FIG. 18 is a view similar to the view of FIG. 17 showing the panel secured in the recess of the van in accordance to a non-limiting practice of the invention.

FIG. 19 is an elevated isometric view of a non-limiting embodiment of a flange engaging member, the flange engaging member of FIG. 19 shown securely mounted in the glazing clip of FIG. 16.

FIG. 20 is an elevated isometric view of still another non-limiting embodiment of a snap-in glazing clip of the invention.

FIG. 21 is an elevated fragmented side view of a panel having the glazing clip of FIG. 20 secured in the recess of the van in accordance to the practice of the invention.

FIG. 22 is an elevated fragment side view of the top portion of the glazing clip of FIG. 20 showing a passageway in body member or elongated body of the glazing clip of FIG. 20.

FIG. 23 is an elevated isometric view of a non-limiting embodiment of a flange engaging member of the invention, the flange member securely mounted in the passageway shown in FIG. 22 in the body of the glazing clip of FIG. 20 in accordance to a non-limiting practice of the invention.

FIG. 24 is an elevated fragment side view of a transparency having a snap-in glazing clip mounted thereto in accordance to a non-limiting practice of the invention.

FIG. 25 is a view similar to view of FIG. 24 illustrating another non-limiting embodiment of the invention to secure a mounting clip of the invention to a transparency.

FIG. 26 is a fragmented side elevated view showing a non-limiting embodiment of the invention for mounting trim to the body of a vehicle.

### DETAILED DISCUSSION OF THE INVENTION

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive on the minimum value of 1 and the maximum value of 10; that is, all subranges beginning with a minimum value of 1 or more and ending with a maximum value of 10 or less, e.g., 1 to 6.7, or 3.2 to 8.1, or 5.5 to 10. Also, as used herein, the terms “deposited over”, “applied over”, or “provided over” mean deposited, applied, or provided on but not necessarily in surface contact with. For example, a material “deposited over” a substrate does not preclude the presence of one or more other materials of the same or different composition located between the deposited material and the substrate.

In the following discussion, non-limiting embodiments of the invention are practice on an automotive van; however, the invention is not limited thereto, and the invention can be practiced with (1) any type of vehicle, e.g. but not limiting the invention thereto, any type of land vehicle, e.g. but not limiting the invention thereto an automobile, a van, a truck, a train; an above water vehicle; a below water vehicle; an air vehicle, or a space vehicle; (2) any type of residential or commercial building; (3) any type of a curtainwall system or cladding for a building, and/or (4) any type of door, e.g. but not limiting the invention, an oven door having a viewing window, a refrigerator door having a viewing window and entrance door having a viewing window. Further, the terminology used herein to discuss the non-limiting embodiments of the invention is for the purpose of description and is not of limitation, and unless indicated otherwise in the following discussion, like numbers refer to like elements.

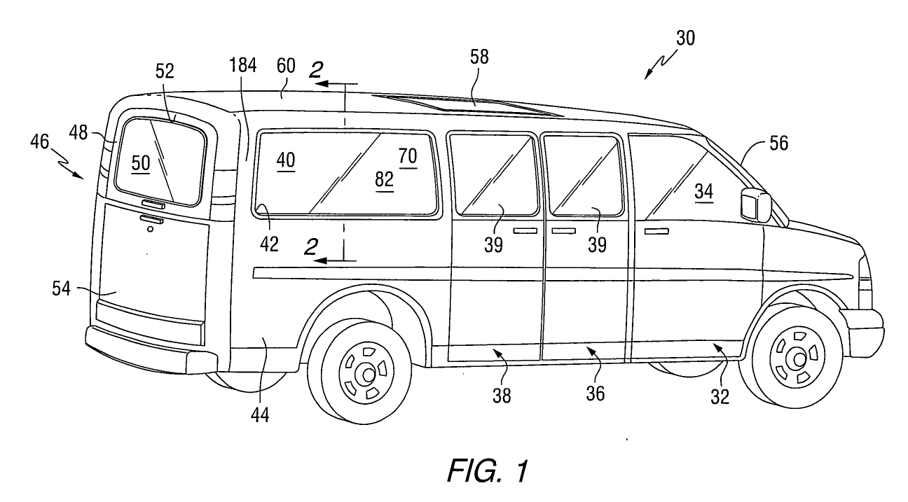

Shown in FIG. 1 is a van 30 having a pair of hinged front doors 32 (only one shown in FIG. 1) having a conventional moveable side window 34; a pair of side doors 36 and 38 each having a panel 39; a panel 40 (also referred to as a quarter panel or quarter window) incorporating features of the invention secured in a recess 42 in body 44 of the van; a rear door 46 having an upper section 48 having a rear window 50 secured in recess 52 in the upper section 48 of the door 46, and having a lower section 54 with the upper and lower sections hinged to the van body 44 in any convenient manner; a windshield 56 secured in a recess (not shown) in the front of the van body 44, and a transparency, or a modular roof panel, or a window secured to a moveable frame, all designated by the number 58 mounted in roof 60 of the van body 44. As can be appreciated, one or both of the side doors 36 and 38 can be hinged to the van body 44 in a similar manner as the front door 32, or one or both of the side doors can be mounted on a track of the type used in the art (not shown) to move the door(s) along a reciprocating path along the side of the van body to provide passenger entrance and exit. Further the invention contemplates the side windows 39 mounted on their respective door 36 and 38 for movement as is known in the art. Still further, the van 30 can have one side door instead of two side doors as shown in FIG. 1.

In the following discussion, non-limiting embodiments of the invention are practiced to secure the panel 40 in the recess 42 in the body 44 of the van 30 shown in FIG. 1. As is appreciated, the invention is not limited thereto, and the invention can be practiced to secure the side windows 39, the rear window 50, the windshield 56, and the roof panel 58 in the body 44 of the van.

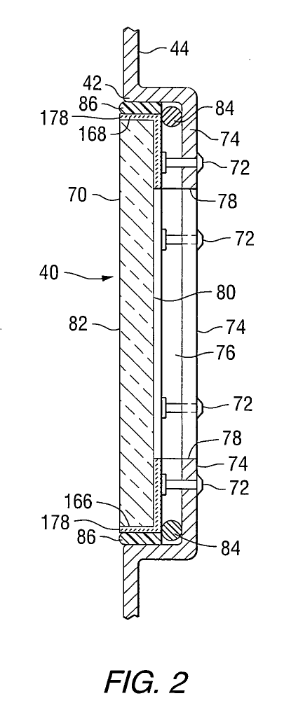

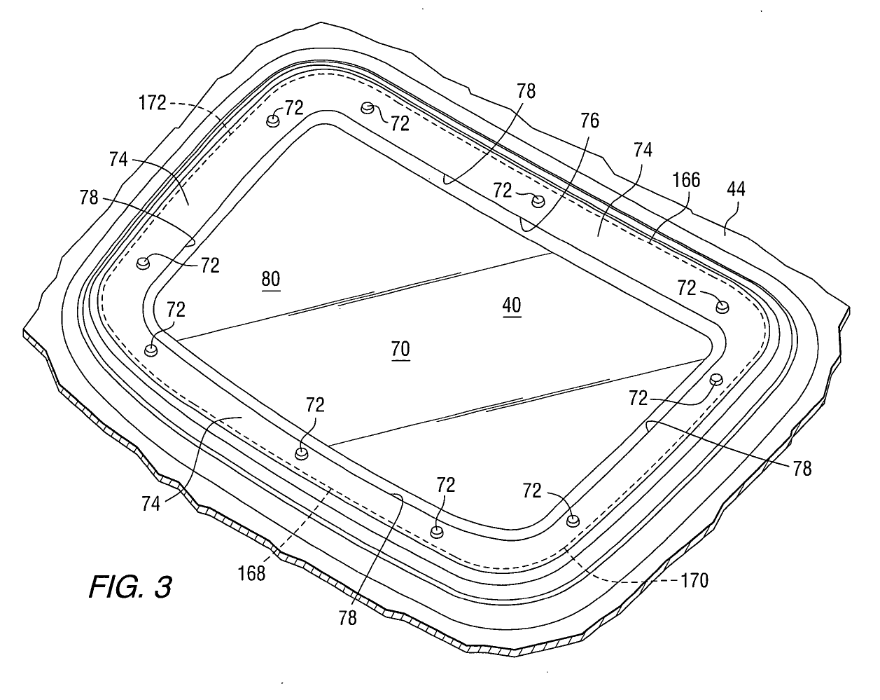

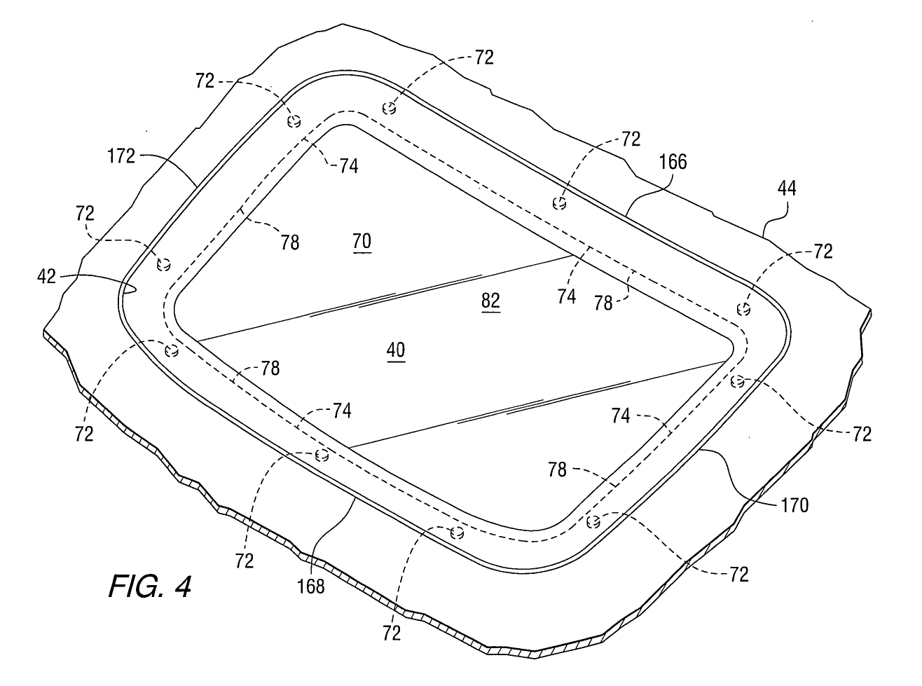

With reference to FIGS. 2-4 as needed, the panel 40 incorporating features of the invention includes a transparency 70, e.g. a tempered glass transparency and snap-in glazing, or mounting clips, of the invention generically shown in FIGS. 2-4, and identified by number 72 that engage flange 74 (see FIGS. 2 and 3) in a manner discussed below to secure the panel 40 in the recess 42 with the transparency 70 over opening 76 (clearly shown in FIG. 2) in the recess 42. As used herein, the terms “glazing clips” and “mounting clips” are used interchangeably. In the following discussion of the non-limiting embodiments of the invention, the opening 76 is an opening or void in the body 44 of the van 30 and/or body part, e.g. a door of the van that provides visual and physical communication between the interior of the vehicle and the exterior of the vehicle. In general, and not limiting to the invention, the opening 76 is in the recess or depression 42 formed in the body 44 of the van 30, and the size of the opening 76 is defined by peripheral edges or end portions 78 of the flange 74. The mounting clips 72 of the invention engage the flange 74 in accordance to the practice of the invention to secure the panel 40 in the recess 42 with the transparency 70 over the opening 76. As is appreciated, the invention is not limited to the shape or material of the transparency 70 and/or the shape of the recess 42 and/or the opening 76. More particularly, inner major surface 80 (surface facing the interior of the van 30, see FIGS. 2 and 3) and outer major surface 82 (surface facing the exterior of the van 30, see FIGS. 2 and 4) of the transparency 70 of the panel 40 can have opposed parallel or non-parallel flat major surfaces, opposed parallel or non-parallel curved major surfaces, or combinations thereof. Further, the transparency 70 can be made of any type of material, for example but not limiting the invention thereto, material selected from the group of plastic; glass fiber, metal fiber and/or carbon fiber reinforced plastic; metal; wood; glass of any type, e.g. but not limiting the invention thereto, glass ceramic, annealed glass, tempered glass, heat strengthened glass, colored glass and clear glass. Still further, the transparency 70 can have any type of coating applied over one or more of the major surfaces 80 and 82, e.g. but not limiting the invention thereto, an environmental coating, an electrically conductive coating, a water repellant coating, and/or a self cleaning coating, and combinations thereof. In addition, the transparency 70 of the panel 40 of the invention can be monolithic or laminated, e.g. but not limiting the invention thereto, a pair of glass sheets, or a glass sheet and plastic sheet, laminated together. In addition, the transparency 70 can be one or both sheets of a double glazed or insulating unit. Further, the panel can be a modular roof, e.g. but not limiting to the type disclosed in U.S. Pat. No. 6,279,989 secured in an opening in the vehicle roof.

In one non-limiting embodiment of the invention, a weather seal 84 and an edge gasket 86 (clearly shown in FIG. 2) is provided between the transparency 70 and the body of 44 of the van 30, more particularly the flange 74, to prevent water from moving between the transparency and the body of the van into the van interior (not shown). The use of weather seals and edge gaskets are well known in the art and no further discussion is deemed necessary,

In another non-limiting embodiment of the invention, the panel 40 is secured in the recess 42 solely by the mounting clips 72 of the invention engaging the flange 74. Stated another way, the weather seal 84 and the edge gasket 86, if present have insufficient adhesive strength to solely secure the transparency 70 of the panel 40 in the recess 42. For example and not limiting to the invention, weather seals usually have a shear strength of no greater that 100 pounds per square inch, for example no greater than 50 pounds per square inch, for example no greater than 20 pounds per square inch, for example no greater than 10 pounds per square inch. In one non-limiting embodiment of the invention, the weather seal 84 is a butyl tape of the type sold by Adco Products, Inc. of Michigan part No. RT0140 and has a shear strength of 8 pounds per square inch and provides minimal if any, structural strength to secure the transparency 70 to the flange 74 defining the opening 76. In another non-limiting embodiment of the invention, the snap-in mounting clips of the invention are used with weather seals having shear strength greater than 10 pounds per square inch.

The discussion is now directed to non-limiting embodiments of the snap-in glazing or mounting clips of the invention to secure the panel 40 in the recess 42 in the body 44 of the van 30. In the practice of the non-limiting embodiments of the invention discussed below, panels of the instant invention like the panels of U.S. application Ser. Nos. 11/486,789; 11/486,790; 11/486,918; and 11/486,919 identified above, can be secured in an recess, e.g. and not limiting to the invention, in the recess 42 in the body 44 in a time period in one of the following ranges: greater than 0 seconds to equal to or less than 30 minutes; greater than 0 seconds to equal to or less than 20 minutes; greater than 0 seconds to equal to or less than 15 minutes, and greater than 0 seconds to equal to or less than 10 minutes.

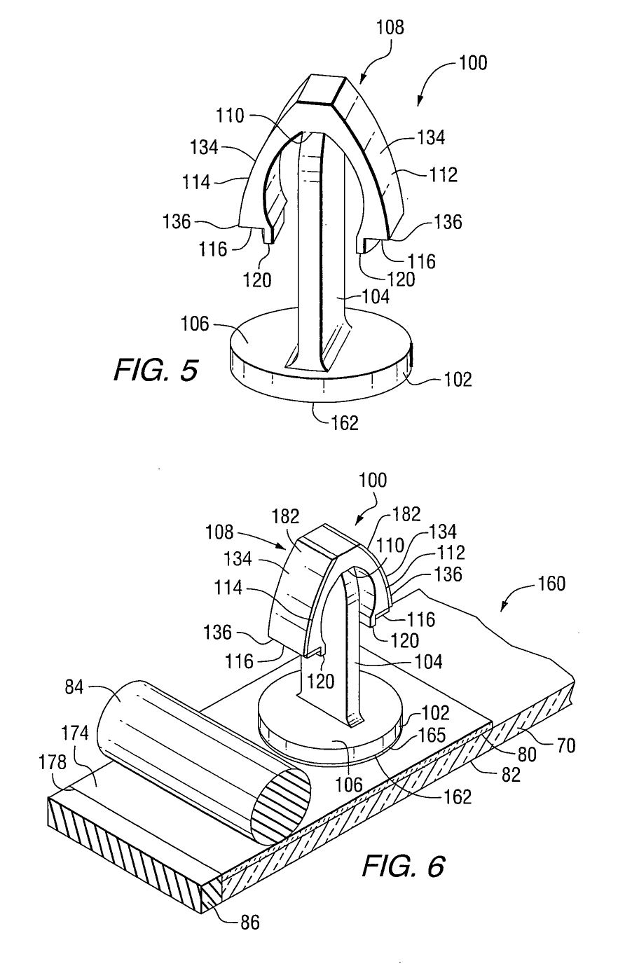

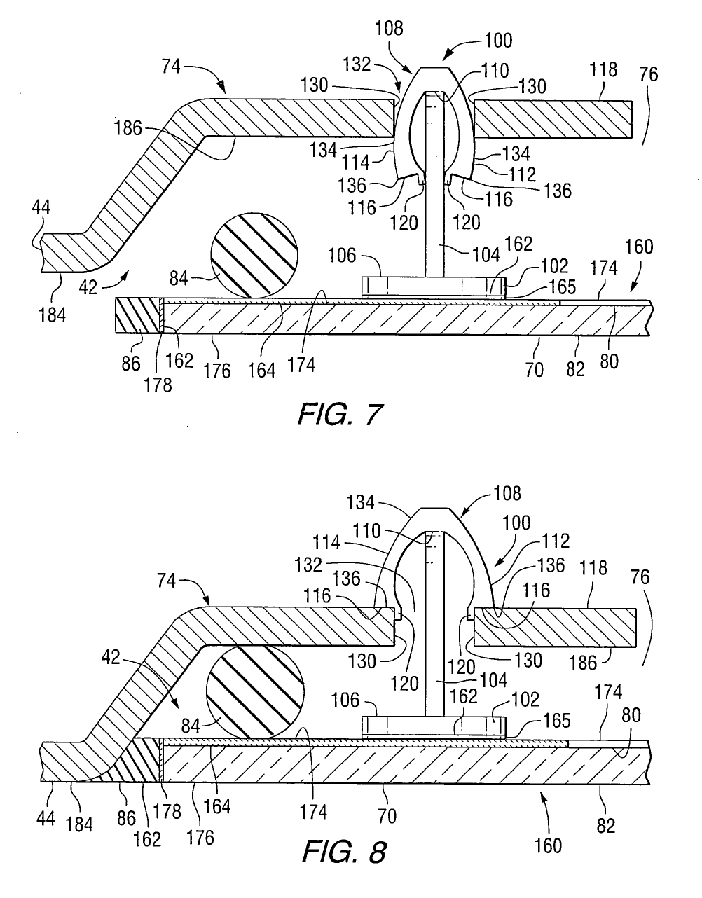

Shown in FIG. 5 is one non-limiting embodiment of a snap-in mounting clip of the invention designated by number 100. With reference to FIGS. 5-8 as needed, the clip 100 includes a base 102 having a body member or elongated member 104 extending from surface 106 of the base 102 and having a flange retaining member 108 secured to the body member 104. The invention is not limited to the configuration of the base 102 and the body member 104. For example and not limiting to the invention, the base 102 is shown in FIG. 5 as a circular disc, however, the invention contemplates the base 102 having a polygon shape having 3 or more sides and having an elliptical shape. Further the body member 104 is shown as having a rectangular shape; however the invention contemplates the body member 104 having a cylindrical shape, a cone shape, or a polygon shape having 3 or more sides. The flange retaining member 108 has a pair of legs or engaging members 112 and 114 that are joined together at least in close proximity to end 110 of the body member 104. In the non-limiting embodiment of the invention shown in FIG. 5, engaging members 112 and 114 extend from the end 110 of the body member 104, with the legs 112 and 114 forming a generally inverted U-shape. Each leg 112 and 114 has a surface 116 for engaging inner surface 118 of the flange 74, i.e. a flange engaging surface 116 facing, and a tab 120 extending toward, the base 102 of the mounting clip 100. The tabs 120 engage portions of inner wall 130 of one of a plurality of holes 132 (only one hole shown in FIGS. 7 and 8) in a manner discussed below.

In the discussion of non-limiting embodiments of the invention, the holes 132 of the flange 74 unless indicated are circular holes. However, the invention is not limited to the shape of the flange hole 132, and the flange hole can have any shape, e.g. but not limiting to the invention, the flange holes 132 can be circular, elliptical and polygon shaped flange holes for example and not limiting to the invention rectangular or square shaped flange holes.

The invention is not limited to the width of the engaging members or legs 112 and 114 of the flange retaining member 108, however the width of the legs 112 and 114 should provide for the legs to be moved toward one another as the flange retaining member 108 is moved through its respective one of the flange holes 132 in a manner discussed below. The distance between outer surfaces 134 of the legs 112 and 114 when the engaging members or legs are in the relaxed position, e.g. in the unbiased position or condition, e.g. the fully unbiased position, increases as the distance from the base decreases with the maximum distance at edge 136 of the flange engaging surface 118 of the legs 112 and 114. The invention is not limited to the maximum distance between the outer surface134 of the legs 112 and 114. In one non-limiting embodiment of the invention, the maximum distance is at least 5% greater than the diameter of the flange holes 132, e.g. 15% greater, or 25% greater than the diameter of the flange holes 132. In this manner, the legs 112 and 114 are moved toward one another against the internal biasing force of the flange retaining member 108 as the legs are moved through the flange hole, and after the engaging surfaces 116 of the legs 112 and 114 clear the flange hole 132, the internal biasing force of the flange retaining member 108 moves the legs 112 and 114 away from one another moving the tabs 120 of the legs 112 and 114 against portions of the inner walls 130 of the flange hole 132. As can be appreciate in the fully biased condition, the engaging legs 112 and 114 are in contact with the body member 104.

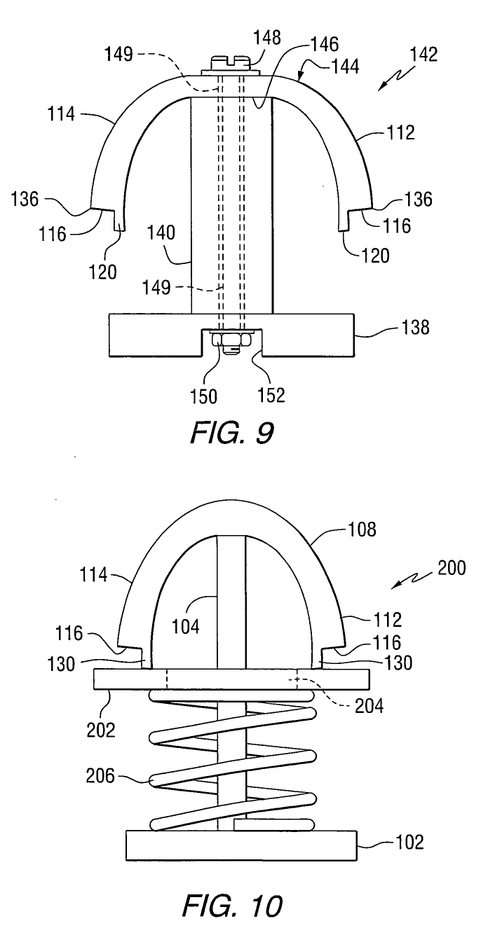

The invention is not limited to the material of the glazing or mounting clips of the invention and the glazing clip can be made of any material, for example and not limiting to the invention, metal or plastic. In one embodiment of the invention, the mounting clip is made of metal, e.g. and not limiting to the invention, steel. Further the components of the glazing clips of the invention, e.g. but not limiting to the invention, the base 102, the body member 104 and the flange retaining member 108 can be made of different materials and joined together in any convenient manner. More particularly, shown in FIG. 9, in one non-limiting embodiment of the invention, base 138 and body member 140 of snap-in glazing clip or mounting clip 142 can be molded from fiber re-enforced polymeric material. Flange retaining member 144 of the glazing clip 142 can be made of spring steel secured to end 146 of the body member 140 by headed screw 148 passing through passageway 149 in the flange retaining member 144, the body member 140 and the base 138, and secured in position by nut 150. Optionally the nut 150 can be positioned in a recess 152 formed in the base138 as shown in FIG. 9.

In the following non-limiting embodiment of the invention, panel 160 (see FIGS. 6-8) including, among other things, the transparency 70 and the snap-in glazing clips 100 is mounted in the recess 42 in the body 44 of the van 30 (van shown in FIG. 1). The peripheral dimensions and configuration of the transparency 70 is not limiting to the invention. In this embodiment of the invention, the transparency 70 or quarter window has a generally rectangular shape (see also FIG. 4) with long sides 166 and 168 having a length of 2.5 feet and short sides 170 and 172 having a length of 2 feet. In one non-limiting embodiment of the invention, the bottom surface 162 of the glazing clip 100 is secured to ceramic band 174 (see also FIG. 3) on the marginal edges 164 of the inner surface 80 of the transparency 70. The ceramic band 174 can be provided on the marginal edges 164 of the inner major surface 80, or marginal edges 176 of the outer major surface 82, of the transparency 70.

The ceramic band 174 prevents ultraviolet degradation of the weather seal 84, and is usually black; however, as is appreciated by those skilled in the art, the ceramic band can be any color. Further, as is appreciated by those skilled in the art, the gasket or edge trim 86 can extend over the outer marginal edges 176 of the transparency 70 to eliminate the need of the ceramic band 174 to protect the weather seal 84 against ultraviolet degradation. In this instant, the mounting clips 100 are secured directly to the marginal edge portions 164 of the inner major surface 80 of the transparency 70. The invention is not limited to the type of adhesive used, e.g. the adhesive layer 165; however the adhesive should be strong enough to prevent separation of the glazing clips from the transparency 70 due to normal pulling and/or pushing of the transparency. In one non-limiting embodiment of the invention, the adhesive layer 165 has a tensile strength of at least 200 pounds, e.g. at least 500 pounds. In one non-limiting embodiment of the invention, the adhesive is a polybutylene terpahthalate. As is appreciated by those skilled in the art, other types of adhesives used to secure components to transparencies, and the suppliers of such adhesives are well known in the art and no further discussion is deemed necessary.

As is appreciated, the invention is not limited to the number of glazing clips of the invention, e.g. but not limited to the glazing clips 100 securely on a transparency 70. In one non-limiting embodiment of the invention, the number of devices per side of the transparency is a function of the expected force to be applied to the transparency to move it out of the recess and/or the force required to compress the weather seal 84 to provide a watertight seal. The factors to be considered, but not limiting to the invention include but are not limited to the compressibility of the weather seal 84, the length of the sides 166, 168, 170 and 172 of the transparency 70, and the strength of the adhesive layer 165 securing the base of the glazing clips to the transparency. In one non-limiting practice of the invention, the center to center spacing between adjacent mounting clips of the invention, e.g. but not limited to the mounting clips 100, and the spacing between the center of a mounting clips and an adjacent side of the transparency 70, is no greater than 10 inches with at least one glazing clip at each side of the transparency.

Referring back to FIGS. 6-8 as needed, in the practice of the invention, but not limited thereto, a plurality of the mounting clips are secured by the adhesive layer 165 on the ceramic band 174 on the inner marginal edge portions 164 of the transparency 70 to provide the panel 160. An elongated piece of the weather seal 84 is positioned on the ceramic band 174 to encircle the mounting devices 100 with the ends of the weather seal 84 contacting one another and optionally secured together by an adhesive (not shown). The flange 74 of the recess 42 in the body 43 of the van 30 has a plurality of spaced ones of the flange holes or slots 132 (only one shown in FIGS. 7 and 8). A gasket of the type known in the art, e.g. the gasket 86 (see also FIG. 2) is provided on the sides 166, 168, 170 and 172 of the transparency 70 (only the side 162 of the transparency 70 shown in FIGS. 6-8) by adhesive layer 178. The invention is not limited to the adhesive of the adhesive layer 178 used to secure the weather seal 84 to the inner marginal edge portions 164, and to secure the edge gasket 86 to the sides 166, 168, 170 and 172, of the transparency 70. In one non-limiting embodiment of the invention, the adhesive of the adhesive layer 165 used to secure the mounting clips 100 to the transparency 70 is also used to secure the weather seal 84 and edge gasket 86 to the transparency 70.

The panel 160 is moved into the recess 42 to move the outer surfaces 134 of the legs 112 and 114 of the flange retaining member 144 into their respective flange hole 132. Moving the panel 160 further into the recess 42 moves the outer surface 134 of the legs 112 and 114 of the flange retaining member 108 of the glazing clip 100 further into the flange hole 132 moving the arms 112 and 114 of the flange retaining member 144 toward one another and the body member 104 as shown in FIG. 7. Continued movement of the panel 160 into the recess 42 compresses the weather seal 84 and moves the flat surfaces 116 of the arms 112 and 114 of their respective flange hole 132, and the arms 112 and 114 of the flange retaining member 108 move away from one another and the body member 104 by the internal biasing force of the flange retaining member 108 to move the tabs 120 of the arms 112 and 114 against a portion of the inner wall 130 of their respective one of the flange holes 132. The force applied to the panel 160 to move the panel into the recess 42 is removed, and the compressed weather strip 84 expands, moving the panel 160 out of the recess 42 and moving the surface 116 of the arms 112 and 114 against the inner surface 118 of the flange 74. In addition, the inner surface 80 of the transparency 70 can be accessed through the opening 76 of the recess 42, and the panel 160 moved out of the recess 42 to move the surfaces 116 against the inner surface 118 of the flange 74. Still further, the panel 160 can be moved out of the recess 42 by applying a vacuum to the outer surface 82 of the transparency 70 to pull the panel 160 out of the recess 42. In a non-limiting embodiment of the invention, the panel 160 is secured in the recess 42 by the compressed weather strip biasing the panel out of the recess, the surface 116 of the flange retaining member 108 engaging the inner surface 118 of the flange 74 and the tabs 120 of the flange retaining member 108 engaging portions of the inner surface 130 of their respective flange hole 132 to prevent the arms 112 and 114 from moving away from one another.

Although not limiting to the invention, to minimize or eliminate noise due to movement of the van resulting in vibrations that move the flange 70 and the flat surface 116 and the tabs 120 of the flange retaining member 108 relative to one another, a layer 180 (shown only in FIG. 6) of a noise absorbent material or a material with surface friction, e.g. but not limited to the invention, a strip of urethane having a tacky surface, e.g. but not limiting to the invention RT0140 is provided on the surface 116 and/or the tabs 120 of the arms 112 and 114 of the flange retaining member 108. Further and not limiting to the invention, a layer 182 of a low friction material (shown only in FIG. 6) on a portion of the outer surface 134 of the leg 114 of the flange retaining member 108), e.g. of the type sold by E.I. DuPont de Nemours and Company, Delaware, under the registered trademark TEFLON can be applied to outer surfaces 134 of the arms 112 and 114 of the flange retaining member for ease of sliding the arms 112 and 114 through their respective flange hole 132. After the panel 160 is fixedly secured in the recess 42, trim (not shown), e.g. interior trim and/or exterior trim is applied as is known in the art.

As can be appreciated, in one non-limiting embodiment of the invention, the tabs 120 of the arms 112 and 114 of the flange retaining member 108 of the glazing clip 100 are maintained in their respective flange hole 132 and biased against portions of the inner surface 130 of the flange hole 132. In this manner, the panel is maintained in the recess 42 with the transparency generally flush with outer surface 184 of the body 44 of the van 30 (see FIG. 8). The parameters that are considered in regards to the foregoing can include one or more of the following: the compressibility of the weather seal 84, the length of the tabs 120, the length of the legs 112 and 114, the expected waviness of the flange 74, the thickness of the transparency 70, and the length of the body member 104 of the glazing clip 100.

The distance from the flat surface 116 of the legs 112 and 114 to the outer surface 82 of the transparency 70 should be sufficient such that with the outer surface 82 of the transparency 70 flush with the outer surface 184 of the van body 44, the surface 116, e.g. but not limiting to the invention, the flat surface 116 are in surface engagement with the inner surface 118 of the flange 74. Although not limiting to the invention, the waviness of the flange 74 usually due to the bending and welding of the metal to form the flange 74 at the opening 76 of the recess 42 is expected to be in the range of plus or minus 1.5 millimeters (“mm”). The waviness results in the distance between the inner surface 118 of the flange 74 and the outer surface 184 of the van body 44 at the recess 42 to have a variation of up to plus or minus 1.5 mm. Therefore the distance between the flat surface 116 of the legs or engaging members 112 and 114 and the outer surface of the transparency should take the variation into account. The invention is not limited to the length of the tabs 120 that engage the inner surface 130 of the flange hole 132; however, the length of the tabs 120 should be sufficient such that the maximum expected movement of the panel 160 into the recess 42 will not move the tabs 120 out of their respective flange hole 132.

The thickness or diameter of the weather seal 84 should take into account the compressibility of the weather seal in order that the compressed weather seal biases the transparency 70 away from outer surface 186 of the flange 74 (see FIGS. 7 and 8) to bias the flat surface 116 of the arms 112 and 114 against the inner surface 118 of the flange 74. With this arrangement, the panel 160 is prevented from moving into the recess 42 a distance to move the tabs 120 of the arms 112 and 114 out of their respective flange hole 132, and the panel resists movement of the transparency into the opening when a force is applied to the outer surface 82 of the transparency 70. For example, a weather seal, e.g. weather seal 84 made of solid butyl rubber can be expected to be compressed up to 50% of its uncompressed thickness; a weather seal made of a hollow butyl rubber rope filled with a foam core can be expected to be compressed up to 80% of it's uncompressed thickness, and a weather seal of a hollow butyl rubber rope can be expected to be compressed up to 80% of its uncompressed thickness. By way of illustration and not limiting to the invention, when the tabs 120 of the engaging members 112 and 114 have a length of 0.5 inches, the remaining thickness that the weather seal 84 can be compressed with the flat surface 116 of the engaging members 112 and 114 engaging the inner surface 118 of the flange 74 is generally no greater than ⅜ inch, e.g. no greater than ¼ inch.

The length of the engaging members 112 and 114, and the length of the body member or elongated member 104 are sufficient to move the flat surface 116 of the legs 112 and 114 out of their respective flange hole 132, and not interfere with the interior trim (not shown) detachable secured over the inner surface 118 of the flange 74.

The snap-in glazing clips 100 of the panel 160 are released from the flange 74 in any convenient manner. For example and not limiting to the invention, the legs 112 and 114 of the flange retaining member 108 are moved toward one another to clear the flat surface 116 of the legs 112 and 114 of the glazing devices from the inner surface 118 of the flange 74 to a position over their respective one of the flange holes 132. Thereafter, the glazing clips 100 are moved through their respective one of the flange holes 132.

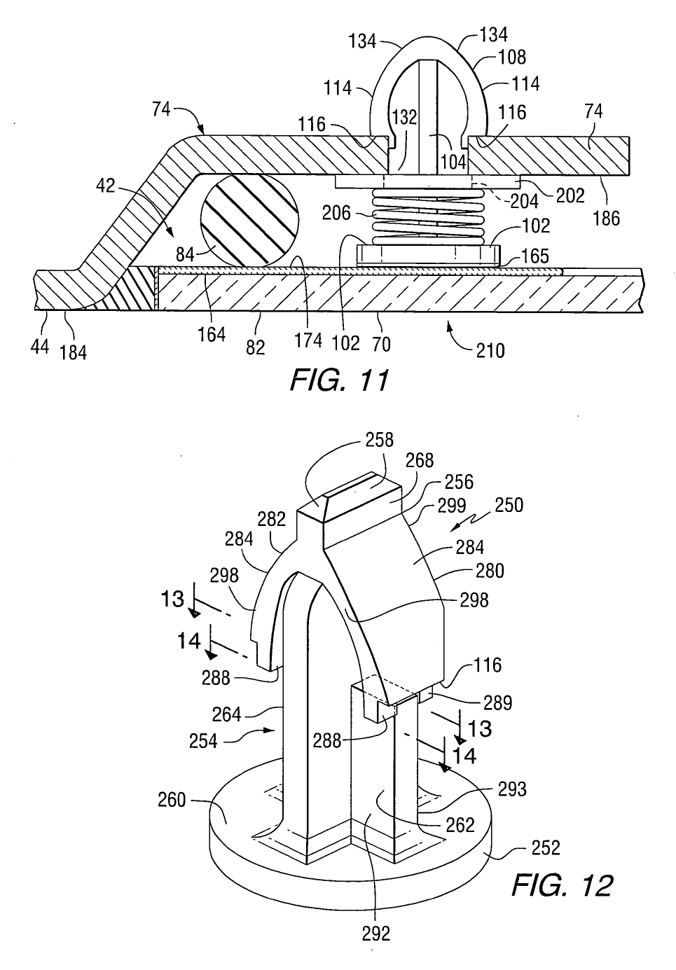

Shown in FIG. 10 is another non-limiting embodiment of a snap-in glazing or mounting clip of the invention designated by number 200. The glazing clip 200 is similar to the glazing clip 100 shown in FIGS. 5-8, and further includes a washer 202 mounted on the body member 104. The outer diameter of the washer 202 is sized to be larger than the diameter of the flange hole 132 of the flange 74 (see FIG. 11), and the diameter of inside hole 204 is equal to the diameter of the base 102 of the glazing clip 200 to pass the washer 202 over the flange retaining member 108. A coil spring 206 is mounted on the body member 104 between the base 102 and the washer 202 and biases the washer 202 against the tabs 130 of the engaging members 112 and 114 of the flange retaining member 108 of the glazing clip 200. A panel 210 having the mounting devices 200 is constructed (see FIG. 11) in a similar manner as the panel 160 discussed above. More particularly, the panel 210 is similar to the panel 160 shown in FIGS. 6-8 except that the panel 210 has the glazing clips 200 secured to the ceramic band 174 on the marginal edges 164 of the transparency 70 whereas the panel 160 has the glazing clips 100 secured to the ceramic band 174 of the marginal edges 164 of the transparency 70. The panel 210 is moved into the recess 42 to move a portion of the outer surface 134 of the engaging members 112 and 114 of each one of the mounting devices 200 into a respective one of the holes 132 of the flange 74 (only one flange hole 132 shown in FIG. 11). After the flange retaining member 108 moves past the outer surface 186 of the flange 74, the washer 202 engages the outer surface 186 of the flange 74. Continued movement of the panel 210 into the recess 42 moves the surface 116 of the legs 112 and 114 of the glazing clips 200 out of the flange hole 132 to move the tabs 120 against portions of the inner wall 130 of the flange hole 132, and to compresses the spring 206 between the washer 202 and the base 102 of the glazing clip 200.

The force applied to the panel 210 to move the panel 210 into the recess 42 is removed, and the basing action of the coil spring 206 moves the panel 210 out of the recess 43 to set the outer surface 82 of the transparency 70 of the panel 210 generally flush with the outer surface 184 of the van body 44 as shown in FIG. 11. Optionally, the strip of urethane having a tacky surface is provided on the engaging surface 116 and/or the tabs 120 of the arms 112 and 114 of the flange retaining member 108. Further and not limiting to the invention, the layer 182 of a low friction material (shown only in FIG. 6 on a portion of the outer surface 134 of the leg 114 of the flange retaining member 108) can be applied to outer surfaces 134 of the legs 112 and 114 of the flange retaining member for ease of sliding the legs 112 and 114 through their respective flange hole 132.

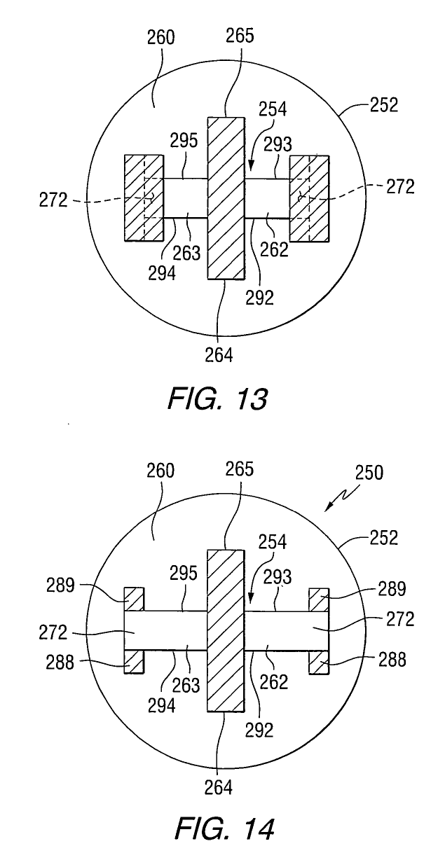

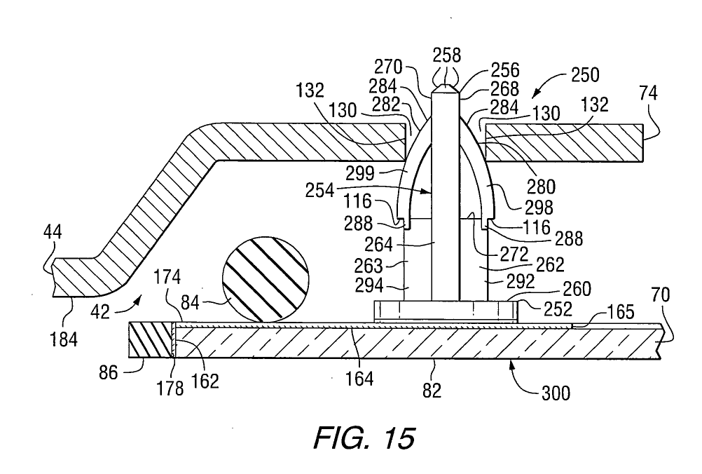

With reference to FIGS. 12-15 as needed, there is shown is shown another non-limiting embodiment of a snap-in glazing or mounting clip of the invention designated by number 250. The glazing clip 250 includes a base 252 and an elongated body member 254 extending away from the base 252 and terminating in an end 256 having downward sloping surfaces 258 for ease of moving the end 256 of the mounting clip 250 into its respective one of the holes 132 of the flange 74 (see FIG. 15). The elongated body member 254 at upper surface 260 of the base 252 has a cross section having an X or + shape (clearly shown in FIGS. 13 and 14) with first pair of opposite extensions, e.g., extensions 262 and 263 of the elongated body member 254 extending a first distance from the surface 260 of the base 252, and a second pair of extensions, e.g. extensions 264 and 265 extending a second distance from the upper surface 260 of the base 252 with the first distance being less than the second distance, and the second distance being less than the distance between the end 256 of the body member 254 and the upper surface 260 of the base 252 to provide a first surface 268 and an opposite second surface 270 (clearly shown in FIG. 15) between the end 256 and the second distance, i.e. top 272 of the second pair of extensions 264 and 265.

A first flexible leg 280 extends from the first surface 268, and a second flexible leg 282 extends from the second surface 270. Each of the legs 280 and 282 has a curved outer surface 284 such that as the legs or engaging members 280 and 282 move through the holes 132 of the flange 74 (only one hole shown in FIG. 15), the legs 280 and 282 are moved from the unbiased position toward one another into a biased position in a similar manner as the legs 112 and 114 of the glazing clips 100 and 200 move through the holes 132 of the flange 74 as discussed above. Each of the legs 280 and 282 at their free end are provided with a pair of spaced tabs 288 and 289, and the engaging surface 116 (clearly shown in FIG. 15). The spaced tabs 288 and 289 of the first leg 280 extend over the sides 292 and 293 respectively of the extension 262, and the spaced tabs 288 and 289 of the second leg 282 extend over the sides 294 and 295, respectively of the extension 263) see also FIG. 14. In this manner, as the legs or engaging members 280 and 282 of the glazing clip 250 are moved toward one another as shown in FIG. 15, the legs 280 and 282 move over the top 272 of the extensions 262 and 263, respectively, and the tabs 288 and 289 of the legs 280 and 282 move along the sides 292, 293 and 294, 295 of their respective one of the extensions 262 and 263 to prevent the legs 280 and 282 from rotating as they move through the flange hole 132 and are biased toward one another. The prevention of arm rotation is of particular interest, but not limiting to the invention, when the width of the legs 280 and 282 as measured between sides 298 and 299 of the arms 280 and 282 (sides 298 and 299 of arm 280 clearly shown in FIG. 12) is greater than the radius, and less the diameter, of a circular hole of a flange, e.g. but not limiting to the invention the hole 132 of the flange 74.

As can be appreciated the extensions 262, 263 and 264, 265 of the elongated member 254 and the flange hole 132 are sized such that the body member can move through the flange hole 132.

With reference to FIG. 15, in one non-limiting embodiment of the invention using the snap-in glazing clip 250, the glazing clip 250 and the weather seal 84 are mounted or secured on the ceramic band 174 on the marginal edge portions 165 of the inner surface of the transparency 70 by the adhesive layer 165, and an edge gasket 86 is mounted or secured on the sides 166, 168, 170 and 172 of the transparency 70 by the adhesive layer 178 (only side 162 of the transparency 70 shown in FIG. 15) in a similar manner as discussed for the panel 160 (see FIGS. 6-8) and the panel 210 (see FIG. 11) to provide a panel 300. The panel 300 is moved into the recess 42 in the body 44 of the van 30 (van shown only in FIG. 1). As the glazing clips 250 move into their respective one of the flange holes 132 (only one flange hole shown in FIG. 15), the outer surface 284 of the arms 280 and 282 engage the flange hole 132 and are moved toward one another. The panel is continually moved into the recess to move the arms 280 and 282 of the glazing clips 250 further into their respective flange hole 132. When the engaging surface 116 at the end of the legs 280 and 282 moves out of the flange hole 132, the arms 280 and 282 move away form one another moving the tabs 288, 289 of the legs 280 and 289 into engagement with portions of the inner surface 130 of the flange hole 132.

The force moving the panel 300 into the recess 42 is removed, and the panel 300 is biased out of the recess 42 by the compressed force of the weather seal 84 or by applying an outward force in any convenient manner, e.g. as discussed above to move the outer surface 82 of the transparency 70 in general alignment with the outer surface 184 of the body 44 of the van 30, e.g. as shown for the panel 160 in FIG. 8. The legs 280 and 289 engaging the inner surface 118 of the flange 74 maintain the panel 300 in the recess 42 against the biasing action applied to the transparency 70 and/or the panel 300.

Optionally, the strip of urethane having a tacky surface is provided on the engaging surface 116 and/or the tabs 288 and 289 of the arms 280 and 282 of the body member 254. Further and not limiting to the invention, the layer 182 of a low friction material (shown only in FIG. 6 on a portion of the outer surface 134 of the leg 114 of the flange retaining member 108) can be applied to outer surfaces 284 of the legs 280 and 282 for ease of sliding the legs 280 and 282 through their respective flange hole 132.

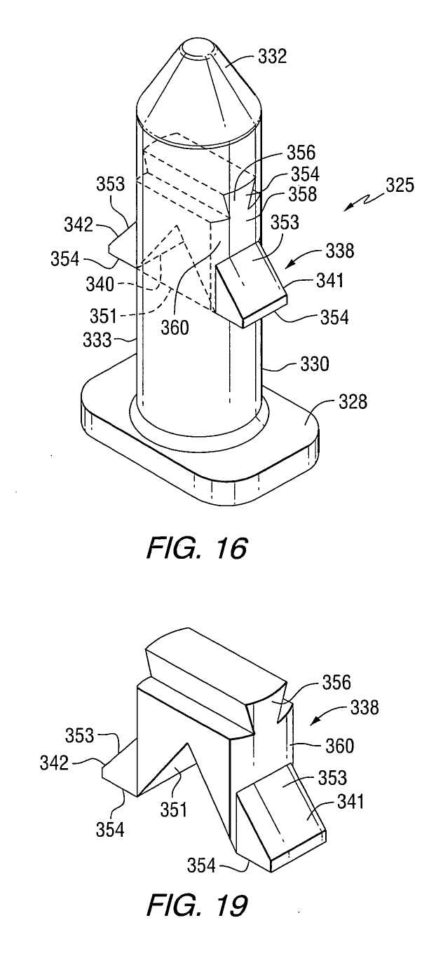

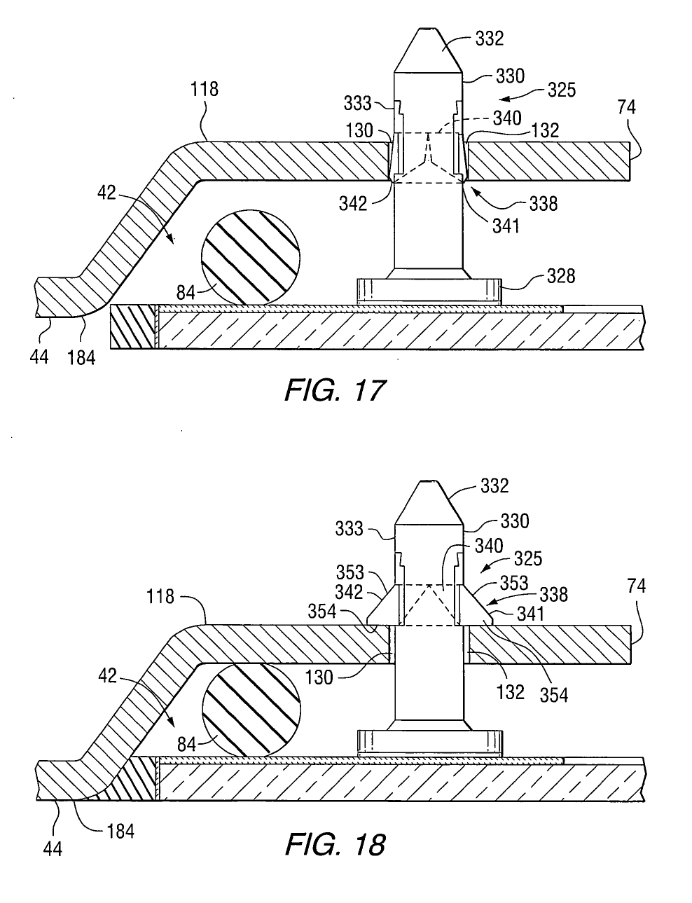

With reference to FIG. 16, there is shown another non-limiting embodiment of a snap-in glazing or mounting clip of the invention designated by the number 325. In general, the glazing clip 325 includes a base 328 having an upright body member 330 extending away from the base 328 and terminating in a cone shaped end 332 for ease of aligning the glazing clip 325 with the hole 132 of the flange 74 (see FIGS. 17 and 18). In one non-limiting embodiment of the invention, the body member 330 has an outer surface 333 configured to match the shape of the inner surface 130 of the flange hole 132. In the non-limiting embodiment of the invention shown in FIG. 16, the outer surface 333 of the body member 330 has an outer circular shape for a circular shape flange hole.

With reference to FIGS. 16 and 19 as needed, the glazing clip 325 further includes a flange engaging insert member 338 (clearly shown in FIG. 19) securely mounted in passageway 340 in the elongated body member 330 in any convenient manner such that flange engaging members 341, 342 of the flange engaging insert member 338 in the unbiased position extend beyond the outer surface 333 of the elongated body member 330 to engage the inner surface 118 of the flange 74 as shown in FIG. 18 in a manner discussed below. In one non-limiting embodiment of the invention, the flange engaging insert member 338 shown in FIGS. 16 and 19 includes a body segment 346 having the pair of legs or engaging members 341, 342 extending away from one another in the unbiased position and a groove 351 between the arms 341, 342. With this arrangement the legs 341, 342 can be moved into the passageway 340 toward one another to pass the body member 330 and the legs 341, 342 through the flange hole 132, and after the arms clear the flange hole 132 the legs 341 and 342 are biased out of the passageway 340 to move over the inner surface 118 of the flange 74. The groove 351 in one non-limiting embodiment of the invention has an inverted V-shaped as shown in FIG. 19.

With reference to FIGS. 16 and 19, the legs 341 and, 342 have a sloping surface 353 for ease of moving the legs 341, 342 into the body member 330 as the body member moves through the flange hole 132 (see FIG. 17), and the legs 341, 342 have an opposite surface 354 to engage the inner surface 118 of the flange 74 (see FIG. 18) in a manner discussed below. Optionally, the strip of urethane having a tacky surface is provided on the engaging surface 354 of the legs 341, 342 of the flange engaging member 338. Further and not limiting to the invention, the layer 182 of a low friction material (shown only in FIG. 6) on a portion of the outer surface 134 of the leg 114 of the flange retaining member 108) can be applied to the sloping surface 353 of the legs 341, 342 for ease of sliding the legs 280 and 282 through their respective flange hole 132.

The invention is not limited to the diameter of the body member 330 or the distance the legs or engaging members 341, 342 extend out of the passageway 340; however, in one non-limiting embodiment of the invention, the body member 330 occupies at least 80%, e.g. at least 90%, of the flange hole 132 to reduce the bending moment on the legs 341, 342, and each of the arms 341, 342 extend over the inner surface 118 of the flange 74 regardless of the position of the body member 330 in the flange hole 132.

In the non-limiting embodiment of the invention shown in FIGS. 16 and 19, the passageway 340 extending through the elongated body member 330 has a passageway 354 shaped to receive keyed portion 356 of the flange engaging insert member 338, and a rectangular shaped portion 358 to receive portion 360 of the flange engaging member 338 having the arms 341, 342 extending therefrom. The flange engaging insert member 338 can be detachably secured in the passageway 340 of the body member 330 by a pressure fit between the keyed portion 354 of the passageway 330 and the keyed portion 356 of the flange engaging insert member 338, or by using an adhesive, for example and not limiting to the invention the adhesive of the adhesive layer 165 to secure the keyed portion 356 in the passageway 354.

The invention is not limited to the material of the flange engaging insert member 338, and the flange engaging member can be made of any material, e.g. but not limiting to the invention, plastic, metal, e.g. spring steel and combinations thereof that provide for the flange engaging arms 341, 342 in the unbiased position to extend out of the elongated body member 330 and in the biased position to move toward and/or into the passageway 340 of the elongated body member 330. In one non-limiting embodiment of the invention, the flange engaging insert member 338 is made of butyl rubber.

With reference to FIGS. 16-18, in one non-limiting embodiment of the invention the snap-in glazing or mounting clip 325, the glazing clip 325 and the weather seal 84 are mounted or secured on the ceramic band 174 on the marginal edge portions 165 of the inner surface of the transparency 70 by the adhesive layer 165, and an edge gasket 86 is mounted or secured on the sides 166, 168, 170 and 172 of the transparency 70 by the adhesive layer 178 (only the side 162 of the transparency 70 shown in FIGS. 17 and 18) in a similar manner as discussed for the panel 160 (see FIGS. 6-8) and the panel 210 (see FIG. 11) to provide a panel 370. The panel 370 is moved into the recess 42 in the body 44 of the van 30 (see FIG. 1). As the glazing clips 325 move into their respective one of the flange holes 132 (only one flange hole shown in FIGS. 17 and 18), sloping surface 353 of the legs 341, 342 engage the flange hole 132 and are moved toward one another into the passageway 340 in the body member 330. The panel 370 is continually moved into the recess 42 to move the legs 348, 349 of the glazing clips 325 further into their respective flange hole 132. When the engaging surface 354 of the legs 341, 342 moves out of the flange hole 132, the legs 341, 342 move away from one another moving the flat surface 354 of the legs 341, 342 over the inner surface 118 of the flange 74.

The force moving the panel 370 into the recess 42 is removed, and the panel 370 is biased out of the recess 42 by the compressed force of the weather seal 84 and/or by applying an outward force in any convenient manner, e.g. as discussed above, to move the outer surface 184 of the transparency 70 of the panel 370 in general alignment with the outer surface 184 of the body 44 of the van 30 as shown in FIG. 18. The legs 341 and 342 engaging the inner surface 118 of the flange 74 maintain the panel 370 in the recess 42 against the biasing action applied to the transparency 70 and/or the panel 370.

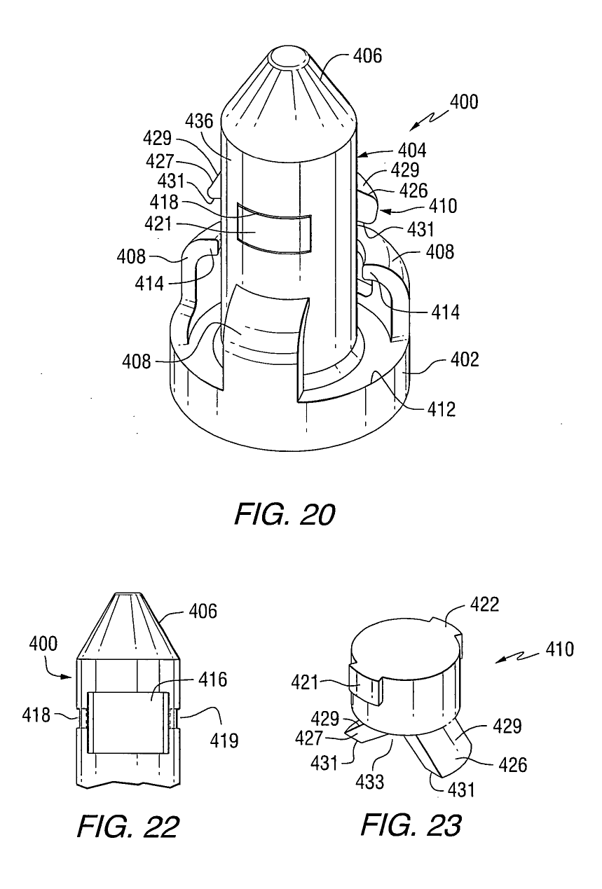

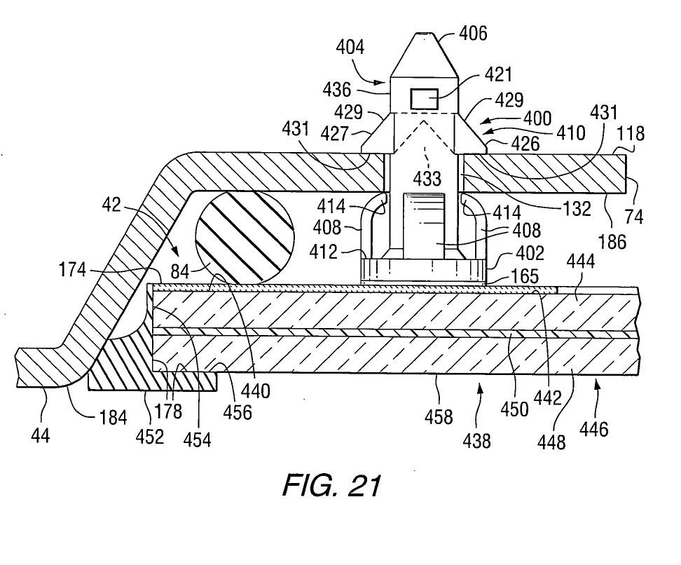

With reference to FIG. 20, there is shown another non-limiting embodiment of a snap-in glazing or mounting clip of the invention assigned the number 400. In general, the glazing clip 400 includes a base 402 having an upright body member 404 extending away from the base 402 and terminating in a flat ended cone shaped end 406 for ease of moving the glazing clip 400 into the hole 132 of the flange 74 (see FIG. 21). The glazing clip 400 further includes a plurality of spring biased members 408 mounted on the base 402 for engaging the outer surface 186 of the flange 74 in a manner discussed below, and an inner surface flange engaging member 410 mounted in the body member 404 in a manner discussed below. The spring members 408 are mounted on upper surface 412 of the base 402 and extend upward from the base 402 spaced from the body member 404 with end portions 414 of each of the spring members 408 bent toward the body member 404. As can be appreciated, the invention is not limited to the number of spring members 408 mounted on the base 402, and the invention anticipates at least 1 spring member, e.g. at least 2 or at least 3.

With reference to FIGS. 20, 22 and 23 as needed, the elongated portion of body member 404 adjacent the cone shaped end 406 has a passageway 416 extending through the body member 404 and a pair of holes 418, 419 (see FIG. 22) opposite to one another and extending through the body member 404 to receive side tabs 421, 422 (clearly shown in FIG. 23), respectively, of flange engaging member 410. In one non-limiting embodiment of the invention, the flange engaging insert member 410 is captured in the passageway 416 of the body member 404 by the side tabs 421, 422 received in the holes 418, 419, respectively. As can be appreciated, the invention is not limited to the manner in which the flange engaging member 410 is secured in the body member 404, e.g. and not limiting to the invention, the flange engaging member 410 can be secured in the body member 404 of the glazing clip 400 in a similar manner as the flange engaging member 338 was secured in the passageway 340 of the body member 330 of the glazing clip 325, discussed above.

The flange engaging member 410 further includes a pair of engaging members or legs 426, 427 each having a sloping surface 429 and an opposite flat surface 431 and a groove 433 between the legs 426, 427. In the unbiased or neutral position, the legs 426, 427 extend beyond outer surface 436 of the body member 404. With this arrangement, the legs 426, 427 can be moved into the passageway 416 toward one another to a biased position to pass the body member 404 and the legs 426, 427 through the flange hole 132, and after the legs clear the flange hole 132, the legs 426, 427 are biased out of the passageway 404 to move over the inner surface 118 of the flange 74. The groove 430 in one non-limiting embodiment of the invention has an inverted V-shaped as shown in FIG. 23.

The invention is not limited to the material of the flange engaging insert member 410, and the flange engaging insert member can be made of any material, e.g. but not limiting to the invention, plastic, metal, e.g. spring steel and combinations thereof that provide for the engaging members 426, 427 in the unbiased position to extend out of the elongated body member 404 and in the biased position moved toward one another and/or into the passageway 416 of the elongated member or body member 404. In one non-limiting embodiment of the invention, the flange engaging insert member 410 is made of butyl rubber.

The sloping surface 429 of the legs 426, 427 provides for ease of moving the arms 426, 427 into the body member 404 as the body member moves through the flange hole 132 (see FIG. 21), and the legs 426, 427 have the opposite flat surface 431 to engage the inner surface 118 of the flange 74 (see FIG. 21) in a manner discussed below. Optionally, the strip of urethane having a tacky surface is provided on the flat surface 431 of the arms 426,427 of the flange engaging member 424. Further and not limiting to the invention, the layer 182 of a low friction material (shown only in FIG. 6 on a portion of the outer surface 134 of the leg 114 of the flange retaining member 108) can be applied to the sloping surface 429 of the legs 426, 427 for ease of sliding the legs through their respective flange hole 132.

The invention is not limited to the diameter of the body member 404 or the distance the legs 426, 427 extend out of the passageway 416; however, in one non-limiting embodiment of the invention, the body member 404 occupies at least 80%, e.g. at least 90%, of the flange hole 132 to reduce the bending moment on the legs 426, 427 and each of the legs 426, 427 extend over the inner surface 118 of the flange 74 regardless of the position of the body member 404 in the flange hole 132.

In one practice of the invention, but not limited thereto, the distance between the end portions 414 of the spring biased members 408 in the unbiased position and the flat surface 431 of the arms 426, 427 in the unbiased position is less than the thickness of the flange 74 as measured between the inner surface 118 and the outer surface 186 of the flange 74, e.g. 2-10% thinner or up to 25% thinner. In this manner, free movement of the glazing clip into and out of the flange hole 132 is minimized, if not eliminated.

With reference to FIG. 21, in one non-limiting embodiment of the invention, a panel 438 of the invention includes a plurality of the snap-in glazing or mounting clip 400 and the weather seal 84 are mounted or secured on the ceramic band 174 on the marginal edge portions 440 of the inner surface 442 of inner sheet 444 of laminated transparency 446 by the adhesive layer 165. The transparency 446 includes the inner sheet 444 and an outer sheet 448 secured to together by a plastic interlayer sheet 450 to provide the laminated transparency 446, for example and not limiting to the invention an automotive windshield. An edge gasket 452 is mounted or secured on the edges of the transparency 444 (only edge 454 of the transparency 444 shown in FIG. 21) and on marginal edge portions 456 of outer surface 458 of the transparency 446 of the outer sheet 448 of the transparency by the adhesive layer 178.

The panel 438 is moved into the recess 42 in the body 44 of the van 30 (van shown only in FIG. 1). As the glazing clips 400 move into their respective one of the flange holes 132 (only one flange hole shown in FIG. 21), sloping surface 429 of the legs 426, 427 engage the flange hole 132 and are moved toward one another to pass the legs 426, 427 into the passageway 416 in the body member 404. The panel 438 is continually moved into the recess 42 to move the arms 426, 427 of the glazing clips 400 further into their respective flange hole 132. As the engaging surface 431 of the legs 426, 427 nears the inner surface 118 of the flange 74, the end portions 414 of the spring stop members 408 engage the outer surface 186 of the flange 74 As the legs 426, 427 move out of the flange hole 132, the arms 426, 427 move away from one another moving the flat surface 431 of the arms over the inner surface 118 of the flange 74 and moving the end portions 414 of the spring members 408 toward the upper surface 412 of the base 402 of the glazing clip 400.

The force moving the panel 438 into the recess 42 is removed, and the panel 438 is biased out of the recess 42 by the biasing action of the spring members 408, by the biasing action of the compressed weather seal 84 and/or by applying an outward force in any convenient manner, e.g. as discussed above, to move the outer surface 458 of the transparency 446 of the panel 438 in general alignment with the outer surface 184 of the body 44 of the van 30 as shown in FIG. 20. The legs 426, 427 engaging the inner surface 118 of the flange 74 prevent the panel 438 from moving out of the recess 42. The spring members 408 engaging the outer surface 183 of the flange 74 of the recess 42 and the compressed weather seal 84 resists any biasing action to move the panel 438 into the recess 43.

The panel 438 can be removed from the recess 42 and/or the glazing clips 400 can be removed from the flange in any convenient manner, e.g. but not limiting to the invention, in the reverse order in which they were installed.

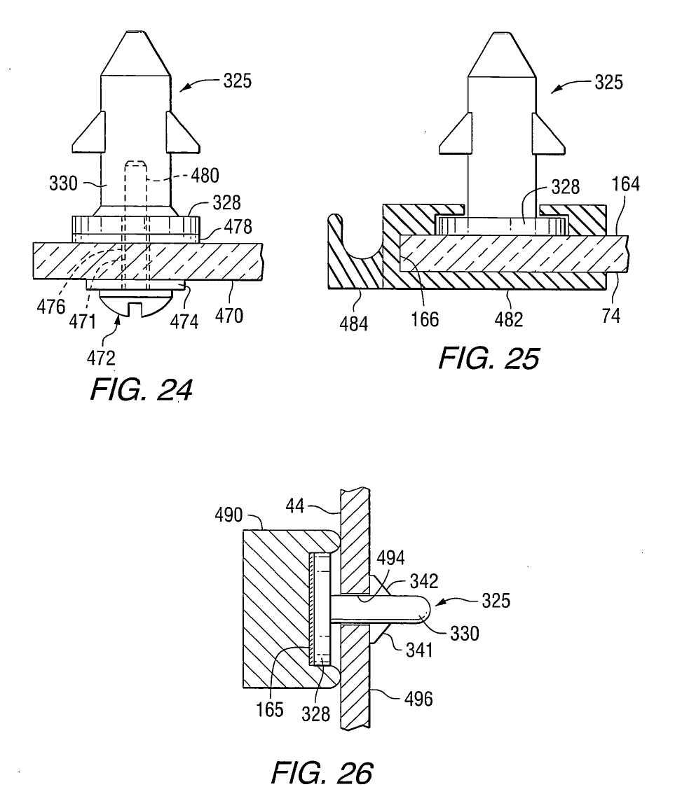

In the non-limiting embodiment of the invention discussed above, the snap-in glazing or mounting clips were secured to a surface of the transparency by a layer of adhesive. The invention, however, is not limited thereto, and the glazing clips of the invention can be securely mounted to a transparency in any usual manner. For example and not limiting to the invention, in FIG. 24 the glazing clip 325 is secured to transparency 470 by shaft 471 of headed screw 472 passing through a rubber washer 474, a hole 476 in the transparency 470 and a second rubber washer 478, with end 480 of the screw 472 threaded through the base 328 and optionally into the body member 330 of the glazing clip 325. In another non-limiting embodiment of the invention, the snap-in glazing clips of the invention are secured or mounted to the transparency by reaction injection molding (also referred to as “RIM encapsulation”). More particular and with reference to FIG. 25, the base 328 of the glazing clip 325 is secured to the inner marginal edge portions 164 of the transparency 70 by RIM encapsulation 482. The RIM encapsulation 482 extends over the inner surface 164, the sides (only side 166 shown in FIG. 24), and outer marginal edge portions 82, of the transparency 70. Optionally an edge gasket 484 can be secured to the RIM encapsulation 482.

As can be appreciated the invention is not limited to the non-limiting embodiments of the snap-in mounting clips discussed above which were presented to illustrate the concept of the invention and constructive non-limiting embodiments of the concepts. Further components of the mounting clips discussed herein can be interchange to provide additional non-limiting embodiments of the mounting clips of the invention.

Although the non-limiting embodiments of the invention were discussed to secure panels in a recess in the body of a van, the invention is not limited thereto and can be used to secure or mount other components together, e.g. and not limiting to the invention, trim to the van body. For example and not limiting to the invention, FIG. 26 shows a piece of body trim 490 secured to the body 44 of the van 30 (van only showed in FIG. 1) by a snap-in mounting or glazing clip of the invention, e.g. the mounting clip 325. The base 328 of the mounting clip 325 is secured to the trim 490 by the adhesive layer 165. The elongated or body member 330 of the mounting clip 325 passes through hole 494 of the van body 44, and the arms 341 and 342 engage inner surface 496 of the van body 44.

While specific embodiments of the invention have been described in detail, it will be appreciated by those skilled in the art that various modifications and alternatives to those details can be developed in light of the overall teachings of the disclosure. Such modifications are to be considered as included within the scope of the invention and accordingly, the particular embodiments described in detail hereinabove are illustrative only and are not limiting as to the scope of the invention, which is to be given the full breadth of the appended claims and any and all equivalents thereof.

What is claimed is:

1. A panel, comprising:
a sheet having a peripheral edge, a first major surface and an opposite second major surface; and
at least one snap-in mounting clip securely mounted on a marginal edge portion of the first major surface of the sheet, the mounting clip comprising:
a base having a first surface in facing relationship to the first surface of the sheet and an opposite second surface;
a body member having a first end and an opposite second end with the first end of the body member secured to the base and the second end spaced and extending away from the second surface of the base; and
first and second flexible engaging members securely mounted on the body member and extending away from one another and the body member toward the second surface of the base, each of the engaging members terminating in an end spaced from the second surface of the base, wherein the engaging members in an unbiased condition have their respective ends spaced a first predetermined distance from one another and in an biased condition have their respective the ends spaced a second predetermined distance from one another, wherein the first predetermined distance is greater than the second predetermined distance.

2. The panel according to claim 1, wherein each of the first and second engaging members have an outer surface, with the distance of the outer surface of the engaging members increasing as the distance from the base decreases, and the end of each of the first and second engaging members comprises a step comprising a first portion and a second portion with the first portion adjacent the outer surface of its respective one of the engaging members and spaced a greater distance from the base than the second portion.

3. The panel according to claim 2, wherein the end of each of the first and second engaging members is a first end and each of the first and second engaging members has an opposite second end with the second end of each of the first and second engaging member joined at least in close proximity to the second end of the body member.

4. The panel according to claim 3, further comprising a plate member mounted on the body member and moveable between the first end of the first and the second engaging member and the second surface of the base, and a biasing member between the plate member and the base to bias the plate member toward the first end of the engaging members.

5. The panel according to claim 4, wherein the biasing member is a coil spring and the body member extends through the coil spring.

6. The panel according to claim 1, wherein the body member adjacent the base has an “+” shaped cross section comprising a first side opposite a second side and a third side opposite a fourth side, and adjacent the second end, the body member has an “I” shaped cross section having the first side opposite the second side, and the first end of each of the first and second engaging members has a groove, wherein the third side of the body member moves through the groove of the first engaging member and the fourth side of the body member moves through the groove of the second engaging member as the first and second engaging members move toward one another.

7. The panel according to claim 6, wherein the end of each of the first and second engaging members is a first end and each of the first and second engaging members has an opposite second end, with the second end of the first and second engaging members joined in at least close proximity to the second end of the body member.

8. The panel according to claim 7, wherein each of the first and second engaging members have an outer surface with the distance of the outer surface of the engaging members increasing as the distance from the base decreases, and the first end of each of the first and second engaging members comprises a step comprising a first portion and a second portion, with the first portion adjacent the outer surface of its respective one of the engaging members and spaced a greater distance from the base than the second portion.

9. The panel according to claim 1, wherein the body member has a passageway adjacent the second end of the body member, and the passageway extending through the body member, with the first and second flexible members moveable into and out of the passageway.

10. The panel according to claim 9, further comprising an insert having the first and second flexible engaging members, the insert mounted in the passageway with the flexible engaging members in the unbiased condition extending out of the passageway beyond outer surface of the body member.

11. The panel according to claim 10, wherein the insert has an upper keyed portion and a lower portion having a center cutout between the flexible members, each of the flexible arms having a flat surface and an opposite downward sloping surface, the passageway sized and configured to receive the insert with the flat surface of the flexible engaging members facing the base, wherein moving the flexible members toward one another into the passageway decreases the size of the cutout and imposes a biasing force on the engaging members to move the engaging members out of the passageway,

12. The panel according to claim 9, wherein the body member has a first center axis extending between the first and second ends of the body member and the passageway has a second center axis traverse to the first center axis, the body member further comprising a first opening and an opposite second opening, the first and second openings extending from the passageway in opposite directions to outer surface of the body member, and further comprising an insert having an first body portion having first and second tabs and a second body portion having the flexible engaging members, the insert mounted in the passageway with the first and second tabs in the first and second openings, respectively, and the flexible engaging members in the unbiased condition extending out of the passageway.

13. The panel according to claim 12, further comprising a plurality of biasing members extending from the second surface of the base toward the second end of the body member.

14. The panel according to claim 13, wherein the plurality of basing members comprises a plurality of spaced spring members mounted in spaced relationship to one another on the second surface of the base around the body member.

15. The panel according to claim 9, wherein the first end of the body member has a cylindrical shape and the second end of the body member has a conical shape.

16. The panel according to claim 1, wherein the sheet has a hole extending from the first surface to the second surface and the snap-in clip has a passageway extending from the first surface of the base toward the second end of the body member, and further comprising a fastener having a headed shaft passing through the hole in the sheet and into the passageway of the snap-in clip, and the head of the fastener engaging the first surface of the sheet.

17. The panel according to claim 1, wherein the sheet is selected from land, air, space, above water and below water vehicular transparency, a transparency for an appliance, a transparency for a window opening, vehicular body trim and combinations thereof.

18. The panel according to claim 34, wherein the sheet is an automotive glass transparency selected from a roof window, a windshield, a side window, a door window and a rear window.

19. The panel according to claim 18, wherein the snap-in clip is one of a plurality of spaced apart snap-in clips securely mounted on a ceramic band on the marginal edge portion of the first major surface of the sheet, and further comprising an elongated weather strip surrounding the plurality of spaced clips, and trim attached to the peripheral edge of the sheet.

20. The panel according to claim 1, wherein selected surfaces of the engaging members have a layer of a low friction material and/or a layer of high friction material.

21. A snap-in mounting clip, comprising:
a base having a major surface;
a body member having a first end and an opposite second end, with the first end of the body member connected to the base and the second end of the body member being spaced and extending away from the major surface of the base; and
first and second flexible engaging members securely mounted on the body member, spaced from the first end of the body member and extending away from one another and the body member toward the major surface of the base, each of the engaging members terminating in an end spaced from the major surface of the base, wherein the engaging members in an unbiased condition have their respective ends spaced a first predetermined distance from one another and the engaging members in an biased condition have their respective ends spaced a second predetermined distance from one another, wherein the first predetermined distance is greater than the second predetermined distance.

22. A method of mounting a panel over an opening in a body, the opening defined by end portions of a flange, the flange having an outer surface facing away from the body, an opposite inner surface and at least one hole, comprising:
providing a panel comprising:
a sheet having a peripheral edge, a first major surface and an opposite second major surface, and
at least one snap-in mounting clip securely mounted on a marginal edge portion of the first major surface of the sheet, the mounting clip comprising:
a base having a first surface in facing relationship to the first surface of the sheet, and an opposite second surface;
a body member having a first end and an opposite second end, with the first end of the body member secured to the base and the second end of the body member spaced and extending away from the second surface of the base; and
first and second flexible engaging members securely mounted on the body member at least in close proximity to the second end of the body member and extending away from one another and the body member toward the second surface of the base, each of the engaging members terminating in an end spaced from the second surface of the base, wherein the engaging members in a fully unbiased condition have their respective ends spaced a first predetermined distance from one another and in a fully biased condition have their respective ends spaced a second predetermined distance from one another, wherein the first predetermined distance is greater than the second predetermined distance;
moving the panel toward the opening to move the second end of the body member of the clip toward the hole in the flange, wherein the flexible engaging members are in the fully unbiased condition; and
continuing the practice of the moving step to sequentially move the second end of the body member into the hole of the flange, move the flexible members toward one another toward the fully biased condition, move the second end of the body member and portions of the engaging member through and out of the hole until the end of the flexible engaging members engage the inner surface of the flange and the flexible engaging members are in one of the following conditions: a biased condition between the fully biased condition and the fully unbiased condition and the fully unbiased condition, to secure the panel over the opening.

23. The method according to claim 22, wherein after the continuing step, biasing the panel away from the outer surface of the flange.

24. The method according to claim 22, wherein the body is an automotive body and the hole in the flange is one of a plurality of holes in the flange and the at least one snap-in clip is one of a plurality of snap-in clips mounted on the marginal edge portion of the panel in spaced relationship to one another, wherein the continuing step is practiced until the ends of the flexible engaging members of each of the plurality of snap-in clips are moved through their respective holes and clear the inner surface of the flange and the ends of the flexible engaging members of the plurality of snap-in clips engage the inner surface of the flange to secure the panel over the opening.

25. The method according to claim 22, wherein the body is an automotive body and the hole in the flange is one of a plurality of holes in the flange and the at least one snap-in clip is one of a plurality of snap in-clips mounted on the marginal edge portion of the panel in spaced relationship to one another, wherein the continuing step is practiced until at least a portion of the end of each of the flexible engaging members of the plurality of snap-in clips engage the inner surface of the flange at their respective hole to secure the panel over the opening.
